(19) United States
(12) Patent Application Publication
(10) Pub. No.: US 2006/0189341 A1
(43) Pub. Date: Aug. 24, 2006

(54) Method of improving power control in a mobile radiocommunication system

(76) Inventor: Pascal Agin, Chatillon (FR)

Correspondence Address: SUGHRUE MION, PLLC, 2100 PENNSYLVANIA AVENUE, N.W., SUITE 800, WASHINGTON, DC, 20037, US

(21) Appl. No.: 10/550,087

(22) PCT Filed: Mar. 17, 2004
(86) PCT No.: PCT/FR04/00655

§ 371 Date: Oct. 18, 2005

(30) Foreign Application Priority Data
Mar. 21, 2003 (FR) 03/03519

(51) Int. Cl. H04B 7/00

(52) U.S. Cl. 455/522

(57) ABSTRACT

A method of improving the performance of a mobile radiocommunication system. According to the invention, a network element, known as the first element of the network transmitting to mobile terminals, receives at least one datum from at least one other network element, known as the second network element, said datum indicating the initial transmission power for transmission to a mobile terminal, in the case of radio link reconfiguration between the first network element and the mobile terminal, which can product a change n the transmission power for the radio link.

The present invention relates generally to mobile radiocommunication systems.

The present invention relates in particular to systems using the CDMA (Code Division Multiple Access) technique.

The CDMA technique is used in particular in so-called third-generation systems, such as, in particular, the Universal Mobile Telecommunication System (UMTS) system.

Generally, mobile radiocommunication systems are subject to standardization, and for a full description of these systems reference can be made to the appropriate standards, published by the appropriate standardization organizations.

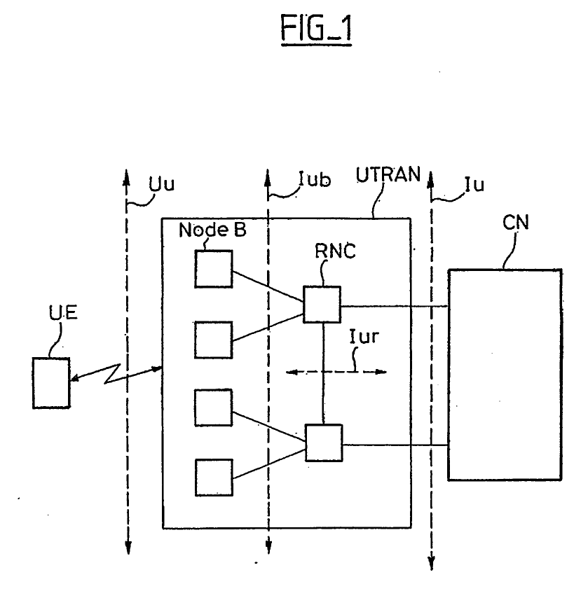

The general architecture of a mobile radiocommunication system such as, in particular, a UMTS type system, is reviewed in FIG. 1. The system comprises a mobile radiocommunication network communicating with mobile terminals or UE (User Equipment) and with external networks (not specifically illustrated).

The mobile radiocommunication network comprises:

a radio access network, or UTRAN (UMTS Terrestrial Radio Access Network),

a core network, or CN.

The third-generation systems, in particular of UMTS type, use a W-CDMA (Wideband—Code Division Multiple Access) type radio access technology. The UTRAN comprises base stations or “nodes B”, and base station controllers or radio network controllers (RNC). The UTRAN is connected on the one hand to the mobile terminals UE, via an interface known as the “Uu” interface (or radio interface), and on the other hand to the CN via an interface known as the “Iu” interface. Within the UTRAN, the nodes B communicate with the RNCs via an interface known as the “lub” interface, and an interface known as the “lur” interface can also be provided between RNCs.

For a given node B, the RNC that controls it is also called CRNC (Controlling Radio Network Controller). The CRNC has a load monitoring role and monitors and allocates radio resources for the nodes B that it controls.

Furthermore, systems such as UMTS use the macro-diversity mode transmission technique (or “soft-handover”) according to which a UE can be connected simultaneously to a number of nodes B, that is, be served simultaneously by a number of serving cells (or active cells).

For a given call relating to a given UE, there is an RNC, called SRNC (Serving Radio Network Controller), having a control role for the call concerned, including radio link set-up and release control functions, and for controlling parameters that can change during a call, such as bit rate, power, spreading factor, etc. The various nodes B to which a UE is connected may or may not be controlled by one and the same RNC. If they are controlled by different RNCs, one of the RNCs has an SRNC role, and the nodes B connected to the UE and not controlled by the SRNC communicate with the SRNC via the RNCs that control them, also called drift RNCs, or DRNC, via the “lur” interface.

As a general rule, different data types can be transmitted in these systems: data corresponding to user or traffic data, and data corresponding to control or signaling data essential to system operation. Different protocols have been defined for the data interchanges between various elements of these systems, in particular:

the RANAP (Radio Access Network Application Part) protocol, as defined in the 3GPP specification TS 25.413, for signaling interchanges between CN and RNC,

the RNSAP (Radio Network Subsystem Application Part) protocol, as defined in the 3GPP specification TS 25.423, for signaling interchanges between RNCs interlinked by an “lur” interface,

the NBAP (Node B Application Part) protocol, as defined in the 3GPP specification TS 25.433, for signaling interchanges between RNC and node B,

the RRC (Radio Resource Control) protocol, as defined in the 3GPP specification TS 25.331, for signaling interchanges between RNC and UE.

Different channel types have been defined for the data interchanges between UE and UTRAN, corresponding to different levels of the communication protocol between UE and UTRAN, that is, from the highest level to the lowest level: logical channels, transport channels and physical channels. There are different types of logical channels, in particular according to the type of data to be transmitted. The data to be transmitted can furthermore have bit rates that differ according to the services and that vary during one and the same call for one and the same service, these various constraints being taken into account at transport channel and physical channel level, through a number of parameters used to define these channels, such as, in particular, the transmission time interval (TTI), the channel-coding type, the spreading factor, etc.

It will also be recalled that a characteristic of the third generation systems such as, in particular, UMTS, is the facility to transport a number of services on one and the same connection, or a number of transport channels on one and the same physical channel. For example, in a system such as UMTS, such transport channels (TrCH) are handled separately according to a channel-coding scheme, before being multiplexed to form a coded composite transport channel (CCTrCH) to be transmitted on one or more physical channels. There can also be a number of CCTrCH for one and the same connection. It should also be remembered that the transmission power is the same for all the transport channels multiplexed on one and the same CCTrCH transmitted on one and the same physical channel (or DPDCH, dedicated physical data channel). More information on these aspects of UMTS can be found in particular in the 3GPP specification TS 25.212.

As a general rule, the third-generation systems, in particular of UMTS type, need to be able to support traffic categories with quality of service (QoS) requirements that can differ widely from one to the next. To guarantee the quality of service at different levels of such a system, a QoS architecture has been defined, in which different bearer services are distinguished (such as, in particular: radio access bearer (RAB) services between CN and UE, radio bearer (RB) services between RNC and UE, etc), and different QoS attributes (such as, in particular, the traffic class, maximum bit rate, guaranteed bit rate, transfer delay, etc).

The RNC handles in particular radio resource management functions, in order, in particular, to guarantee system performance, in terms of capacity and quality of service.

In CDMA systems, the capacity limitations on the radio interface are fundamentally different from those that apply in systems using other multiple access techniques, such as, in particular, the TDMA (Time Division Multiple Access) technique. The TDMA technique is in particular used in the so-called second-generation systems such as GSM (Global System for Mobile communications). In CDMA systems, all the users share the same frequency resource at all times. The capacity of these systems is therefore limited by the interference factors, these systems also being called for this reason “soft limited systems”.

This is why, in CDMA systems, the radio resource management functions include in particular algorithms such as so-called load control algorithms to prevent overloads, detect them and correct them, and so-called radio admission control algorithms, to decide whether the capacity of a cell that is not being used at a given instant is sufficient to accept a call (that is, to set up a new radio link or an additional radio link) in this cell, according to various parameters such as the service required for this call, the required quality of service, etc.

A typical radio admission control algorithm is based on the transmission power of the node B in the downlink direction, and on the interference level in the uplink direction. More specifically, in the downlink direction, the radio admission algorithm checks whether there is sufficient node B transmission power remaining to accept a new radio link or an additional radio link. For such an algorithm, a major problem is therefore how to estimate what transmission power is required in the downlink direction for a new radio link or an additional radio link. The performance of this algorithm and therefore the performance of the system depend on the quality of this estimation.

Moreover, the UMTS standard is flexible regarding the location of the radio admission algorithm in the system. In particular, such an algorithm can be implemented in the node B or in the RNC, even partly in one and partly in the other. If the radio admission algorithm or a part thereof is implemented in the node B, or in any case where a knowledge of the initial power is necessary at the node B itself, for example, even to use this power as initial transmission power for the power control algorithm, in particular to improve the performance of this algorithm, specific problems arise. These specific problems are due to the fact that the estimation of the initial power by the node B itself is difficult, because the node B does not have all the knowledge required for this estimation.

In particular, the node B has no knowledge of certain information that the RNC knows from its control functions. For example, the RNC knows the quality of service required for the call, which is communicated to it by the CN during call set-up, and which is needed for radio bearer (RB) set-up. According to another example, for the case of transmission in macro-diversity mode, the RNC knows the transmission power required for other radio links for the same UE with other nodes B, because the RNC itself determines a so-called reference transmission power for the different radio links for one and the same UE with different nodes B.

This is why, in the current state of the UMTS standard, provision is made for the RNC to signal to the node B (via the NBAP protocol) the initial transmission power required for the downlink direction. However, in the current state of the standard, this is provided only for the case of a new radio link (or radio link set up following receipt by the node B of the “radio link set-up” message) or for the case of an additional radio link (or radio link set up following receipt by the node B of the “radio link addition” message).

However, as the applicant has observed, there is another case where it would be important for the node B to know the transmission power required for a radio link. This case corresponds to the case where a radio link is reconfigured (for example, when the spreading factor, or any parameter used to define the transport or physical channels for this radio link) is changed, etc. For example, an important radio link reconfiguration case is the one that occurs at the start of a call. In practice, when a call is set up:

in a first step, when a first radio link is set up, the RNC configures only the control channels, or DCCH (Dedicated Control Channel), or logical channels used at the start of a call to transport the signaling according to the RRC (Radio Resource Control) protocol between RNC and UE and NAS (Non-Access Stratum) protocol between CN and UE,

then, in a second step, once the CN has determined how the call must be handled, and transmitted to the RNC the radio access bearer set-up request or RAB (RAB Assignment Request) message with information on the service required and the required quality of service, the RNC sends to the node B a radio link reconfiguration message, in order, in particular, to add traffic channels, or DTCH (Dedicated Traffic Channel) logical channels and to change the parameters of the physical channels. This second step normally requires a significant increase in transmission power (in practice, typically, the bit rate transported by the DCCH channels is only between 3 and 4 kbit/s, whereas the bit rate transported by the DTCH channels can be much higher).

In the current state of the standard, no provision is made for the RNC to signal to the node B the initial transmission power required for the downlink direction, following a radio link reconfiguration. More specifically, in the current state of the standard, for the UMTS FDD (Frequency Division Duplex) mode, provision is made only for the RNC to signal to the node B the initial transmission power required for the downlink direction, in a “Radio Link Set-up” message (in the case of creation of a new radio link) or “Radio Link Addition” message (in the case of creation of an additional radio link). For the UMTS TDD (Time Division Duplex) mode, provision is also made for the RNC to signal to the node B the initial transmission power required for the downlink direction, in a “Radio Link Reconfiguration Prepare” message, but, as indicated in the 3GPP specification TS 25.433, the initial transmission power signaled in this way is to be applied by the node B when it begins to transmit on a new CCTrCH channel. Thus, this latter case corresponds to the case of creation of a new CCTrCH channel, and not to the case of reconfiguration of an already created CCTrCH channel.

As the applicant has observed, radio link reconfiguration case is therefore not currently handled optimally. In particular, the case of radio link reconfiguration which can result in a change in the transmission power for at least one transmission entity on the radio link, for which a transmission power can be defined (such a transmission entity possibly corresponding in particular to a DPDCH channel, or to a CCTrCH channel, or, more generally, to any channel type for which the same type of problem arises) is not taken into account. The result is degraded performance, in particular a performance degradation affecting the radio admission control and power control algorithms, or, more generally, a system performance degradation, in particular in terms of capacity and quality of service.

The main object of the present invention is to avoid all or some of these drawbacks and, more generally, to improve the performance of these systems.

One subject of the present invention is a method of improving the performance of a mobile radiocommunication system, in which method a network element, known as the first network element, transmitting to mobile terminals, receives at least one information element from at least one other network element, known as the second network element, said information element indicating the initial transmission power for transmission to a mobile terminal, in the case of radio link reconfiguration between said first network element and said mobile terminal, which can produce a change in the transmission power for this radio link.

According to another characteristic, said first network element corresponds to a base station, or node B in a UMTS type system.

According to another characteristic, said second network element corresponds to a base station controller, or radio network controller (RNC) in a UMTS type system.

According to another characteristic, said second network element corresponds to a network element having a function for controlling communication with said mobile terminal, including a radio link reconfiguration control function, in particular, in a UMTS Type system, a radio network controller or RNC having an SRNC (Serving Radio Network Controller) role.

According to another characteristic, said second network element corresponds to a network element controlling said first network element, in particular, in a UMTS type system, a radio network controller or RNC controlling a node B or having a CRNC (Controlling Radio Network Controller) role for this node B.

According to another characteristic, in particular in a UMTS type system, said information element indicating initial transmission power is transmitted from an RNC having an SRNC role and a CRNC role for a node B, to this node B, according to the NBAP (Node B Application Part) protocol.

According to another characteristic, said second network element corresponds to a network element not controlling said first network element, and said first network element receives said information element indicating the initial transmission power, from said second network element, via a third network element controlling said first network element, in particular, in a UMTS type system, via a radio network controller or RNC having a DRNC (Drift Radio Network Controller) role.

According to another characteristic, in particular in a UMTS type system, said information element indicating initial transmission power is transmitted from an RNC having an SRNC role, to an RNC having a DRNC role and a CRNC role for a node B, according to the RNSAP (Radio Network Subsystem Application Part) protocol, then retransmitted from this latter RNC to the node B, according to the NBAP (Node B Application Part) protocol.

According to another characteristic, said information element is received in a radio link reconfiguration command message.

According to another characteristic, said information element is received in a synchronized radio link reconfiguration command message.

According to another characteristic, said information element is received in an unsynchronized radio link reconfiguration command message.

According to another characteristic, in a UMTS type system, said radio link reconfiguration command message corresponds to a “radio link reconfiguration prepare” message.

According to another characteristic, in a UMTS type system, said radio link reconfiguration command message corresponds to a “radio link reconfiguration request” message.

According to another characteristic, said initial transmission power is used by said first network element for a radio admission control algorithm.

According to another characteristic, said initial transmission power is used by said first network element for a power control algorithm.

Another subject of the present invention is a network element, including means for implementing a method according to the invention.

Another subject of the present invention is a base station controller, or node B, including means for implementing a method according to the invention. Another subject of the present invention is a base station controller, or radio network controller or RNC, including means for implementing a method according to the invention.

Another subject of the present invention is a mobile radiocommunication system, including means for implementing a method according to the invention.

Another subject of the present invention is a base station controller including means for transmitting to a base station at least one information element indicating the initial transmission power for transmission to a mobile terminal, in the case of radio link reconfiguration between said base station and said mobile terminal, which can produce a change in the transmission power for this radio link.

Another subject of the present invention is a base station controller, including means for transmitting to a base station controller at least one information element indicating the initial transmission power for transmission to a mobile terminal, in the case of radio link reconfiguration between a base station and said mobile terminal, which can produce a change in the transmission power for this radio link.

Another subject of the present invention is a base station controller, including means for receiving from a base station controller at least one information element indicating the initial transmission power for transmission to a mobile terminal, in the case of radio link reconfiguration between a base station and said mobile terminal, which can produce a change in the transmission power for this radio link, and for retransmitting said information element to said base station.

Another subject of the present invention is a base station including means for receiving from a base station controller at least one information element indicating the initial transmission power for transmission to a mobile terminal, in the case of radio link reconfiguration between said base station and said mobile terminal, which can produce a change in the transmission power for this radio link.

According to another characteristic, said base station includes means for using said information element for a radio admission control algorithm.

According to another characteristic, said base station includes means for using said information element for a power control algorithm.

Other objects and characteristics of the present invention will become apparent from reading the description that follows of exemplary embodiments, given in relation to the appended drawings in which:

FIG. 1, described previously, reviews the general architecture of a mobile radiocommunication system, such as, in particular, the UMTS system,

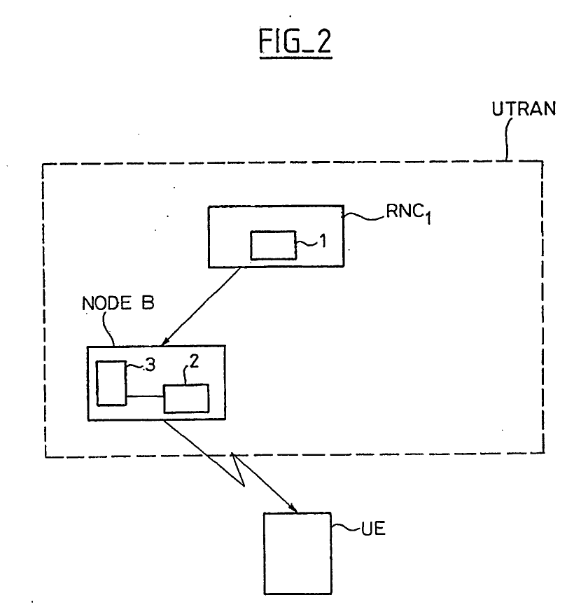

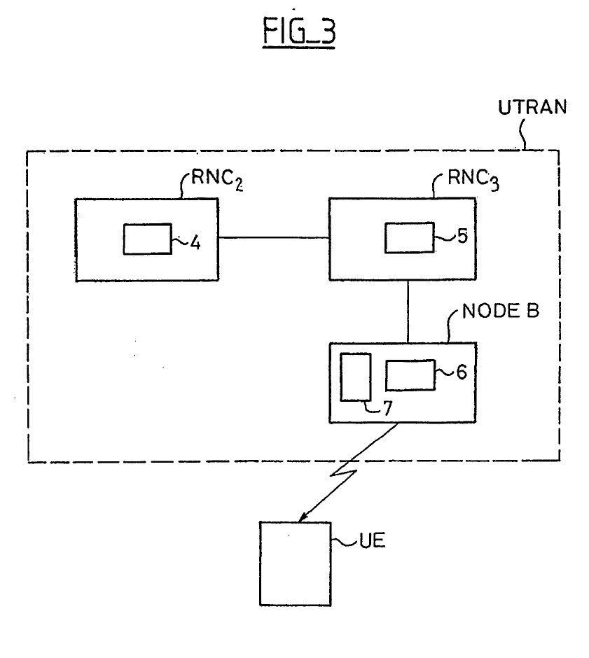

FIGS. 2 and 3 are diagrams for respectively illustrating a first and a second exemplary embodiment of a method according to the invention.

The present invention can also be explained as follows.

The present invention proposes, in particular, to provide an estimation of the transmission power required in the downlink direction, in the RNC, and signal the duly obtained value to the node B, such that the node B can use it as the initial transmission power and can also use it for radio admission control, if the latter is implemented in the node B.

The present invention proposes in particular that the RNC signal to the node B the initial transmission power of a radio link, in the case where this radio link is reconfigured (that is, in any case of change for this radio link, that can produce a change in the transmission power). In particular, this can occur if physical or transport channel parameters are modified for this radio link (for example, the spreading factor, the channel coding, the transmission time interval (TTI), etc), if transport channels are added or deleted, if the service or quality of service changes, etc. As explained previously, a particular important radio link reconfiguration case is the one that occurs at the start of a call.

Advantageously, the initial power for the downlink direction (or “Initial DL Power”, where DL stand for “Downlink”) for the reconfigured radio link can be signaled in the same messages as those used to reconfigure the radio link.

It will be noted that there are different ways of reconfiguring a radio link:

synchronized radio link reconfiguration,

unsynchronized radio link reconfiguration.

In this context, synchronization refers to the reconfiguration of all the radio links at the same moment for the different nodes B with which a UE is connected (in the case where a UE is in “soft-handover” mode with different nodes B).

In the synchronized reconfiguration case, two reconfiguration command messages are sent by the RNC to the node B:

“Radio Link Reconfiguration Prepare”,

“Radio Link Reconfiguration Commit”.

According to a preferred example, the message used to signal the initial transmission power of a radio link in the case of reconfiguration of this radio link is the first message (Radio Link Reconfiguration Prepare), the second message (Radio Link Reconfiguration Commit) normally giving only the instant at which reconfiguration takes place, all the reconfiguration information being given in the first message.

In the case of unsynchronized reconfiguration, just one message is sent by the RNC to the node B:

“Radio Link Reconfiguration Request”.

The invention proposes in particular to add an information element (IE) called “Initial DL Transmission Power” to one and/or the other of the two aforementioned messages, that is “Radio Link Reconfiguration Prepare” and “Radio Link Reconfiguration Request”.

Also, the normal way of defining a transmission power, as defined in particular in the 3GPP specification TS 25.433 is reviewed below:

for the FDD (Frequency Duplex Division) mode: the power level relative to the power of the primary CPICH channel (where CPICH stands for “Common Pilot CHannel”) and by referring to the DPDCH (Dedicated Physical Data Channel) symbols transmitted,

for the TDD mode: the power level relative to the power of the primary CPICH channel.

The present invention thus proposes in particular that a network element, known as the first network element, transmitting to mobile terminals, receives at least one information element from at least one other network element, known as the second network element, indicating the initial transmission power for transmission to a mobile terminal, in the case of radio link reconfiguration between said first network element and said mobile terminal, which can produce a change in the transmission power for this radio link.

In particular, said change in the transmission power corresponds to a change in the transmission power for at least one transmission entity on this radio link, for which a transmission power can be defined.

Said first network element corresponds in particular to a base station, or node B in a UMTS type system.

Said second network element corresponds in particular to a base station controller, or radio network controller (RNC), in a UMTS type system.

Said second network element can in particular correspond to a network element having a function for controlling communication with said mobile terminal, including a radio link reconfiguration control function, in particular, in a UMTS type system, a radio network controller or RNC having an SRNC (Serving Radio Network Controller) role.

According to a first embodiment, said second network element can in particular correspond to a network element controlling said first network element, in particular, in a UMTS type system, a radio network controller or RNC controlling a node B or having a CRNC (Controlling Radio Network Controller) role for this node B.

According to this first embodiment, in a UMTS type system, said information element indicating the initial transmission power can in particular be transmitted from an RNC having an SRNC role and a CRNC role for a node B, to this node B, according to the NBAP (Node B Application Part) protocol.

According to a second embodiment, said second network element can in particular correspond to a network element not controlling said first network element, and said first network element can receive said information element indicating the initial transmission power, from said second network element, via a third network element controlling said first network element, in particular, in a UMTS type system, via a radio network controller or RNC having a DRNC (Drift Radio Network Controller) role.

According to this second embodiment, in a UMTS type system, said information element indicating the initial transmission power can in particular be transmitted, from an RNC having an SRNC role, to an RNC having a DRNC role and a CRNC role for a node B, according to the RNSAP (Radio Network Subsystem Application Part) protocol, then retransmitted from the latter RNC to the node B, according to the NBAP (Node B Application Part) protocol.

In particular, said information element indicating the initial transmission power can be transmitted in a radio link reconfiguration command message, synchronized or unsynchronized, in particular, in a UMTS type system, one and/or the other of the following messages, provided according to the NBAP and RNSAP protocols:

“Radio Link Reconfiguration Prepare”,

“Radio Link Reconfiguration Request”.

FIG. 2 is a diagram for illustrating an example of means that can be provided to implement a method according to the invention, by way of example in a UMTS type system, and in the first exemplary embodiment mentioned above.

In this first exemplary embodiment, said information element indicating the initial transmission power is transmitted from an RNC, designated RNC₁, having an SRNC role and a CRNC role for a node B, to this node B, for example in a reconfiguration command message transmitted according to the NBAP protocol.

RNC₁ thus includes (in addition to other means that can be conventional means):

means designated 1 for transmitting said information element to the node B, in an NBAP message, for example a reconfiguration command message such as “Radio Link Reconfiguration Prepare” or “Radio Link Reconfiguration Request”.

The node B thus comprises (in addition to other means that can be conventional means):

means designated 2 for receiving said information element from RNC₁,

means designated 3 for using said information element, for example for a radio admission control algorithm and/or a power control algorithm, as indicated previously.

FIG. 3 is a diagram for illustrating an example of means that can be provided to implement a method according to the invention, as an example in a UMTS type system, and in the second exemplary embodiment mentioned above.

In this second exemplary embodiment, said information element indicating the initial transmission power is transmitted from an RNC, designated RNC₂, having an SRNC role, to an RNC designated RNC₃, having a DRNC role and a CRNC role for a node B, for example in a reconfiguration command message transmitted according to the RNSAP protocol, then retransmitted from RNC₃ to the node B, for example in a reconfiguration command message transmitted according to the NBAP protocol.

RNC₂ thus includes (in addition to other means that can be conventional means):

means designated 4 for transmitting said information element to RNC₃, in an RNSAP message, for example a reconfiguration command message, such as “Radio Link Reconfiguration Prepare” or “Radio Link Reconfiguration Request”.

RNC₃ thus includes (in addition to other means that can be conventional means):

means designated 5 for retransmitting said information element to the node B, in an NBAP message, for example a reconfiguration command message, such as “Radio Link Reconfiguration Prepare” or “Radio Link Reconfiguration Request”.

The node B thus includes (in addition to other means that can be conventional means):

means designated 6 for receiving said information element from the RNC₃,

means designated 7 for using said information element, for example for a radio admission control algorithm and/or a power control algorithm, as indicated previously.

These various means can function according to the methods described previously; since their particular embodiment presents no particular difficulties for those skilled in the art, such means do not need to be described here in any more detail than by their function.

1. Method of improving the performance of a mobile radiocommunication system, in which method a network element, known as the first network element, transmitting to mobile terminals, receives at least one information element from at least one other network element, known as the second network element, said information element indicating the initial transmission power for transmission to a mobile terminal, in the case of radio link reconfiguration between said first network element and said mobile terminal, which can produce a change in the transmission power for this radio link.

2. Method according to claim 1, in which said first network element corresponds to a base station, or node B in a UMTS type system.

3. Method according to claim 1, in which said second network element corresponds to a base station controller, or radio network controller (RNC) in a UMTS type system.

4. Method according to claim 1, in which said second network element corresponds to a network element having a function for controlling communication with said mobile terminal, including a radio link reconfiguration control function, in particular, in a UMTS type system, a radio network controller or RNC having an SRNC (Serving Radio Network Controller) role.

5. Method according to claim 1, in which said second network element corresponds to a network element controlling said first network element, in particular, in a UMTS type system, a radio network controller or RNC controlling a node B or having a CRNC (Controlling Radio Network Controller) role for this node B.

6. Method according to claim 4, in which said second network element corresponds to a network element controlling said first network element, in particular, in a UMTS type system, a radio network controller or RNC controlling a node B or having a CRNC (Controlling Radio Network Controller) role for this node B, and further in which, in particular in a UMTS type system, said information element indicating initial transmission power is transmitted from an RNC having an SRNC role and a CRNC role for a node B, to this node B, according to the NBAP (Node B Application Part) protocol.

7. Method according to claim 1, in which said second network element corresponds to a network element not controlling said first network element, and said first network element receives said information element indicating initial transmission power, from said second network element, via a third network element controlling said first network element, in particular, in a UMTS type system, via a radio network controller or RNC having a DRNC (Drift Radio Network Controller) role.

8. Method according to claim 4, in which said second network element corresponds to a network element not controlling said first network element, and said first network element receives said information element indicating initial transmission power, from said second network element, via a third network element controlling said first network element, in particular, in a UMTS type system, via a radio network controller or RNC having a DRNC (Drift Radio Network Controller) role, and further in which, in particular in a UMTS type system, said information element indicating initial transmission power is transmitted from an RNC having an SRNC role, to an RNC having a DRNC role and a CRNC role for a node B, according to the RNSAP (Radio Network Subsystem Application Part) protocol, then retransmitted from this latter RNC to the node B, according to the NBAP (Node B Application Part) protocol.

9. Method according to claim 1, in which said information element is received in a radio link reconfiguration command message.

10. Method according to claim 1, in which said information element is received in a synchronized radio link reconfiguration command message.

11. Method according to claim 1, in which said information element is received in an unsynchronized radio link reconfiguration command message.

12. Method according to claim 9, in which, in a UMTS type system, said radio link reconfiguration command message corresponds to a “radio link reconfiguration prepare” message.

13. Method according to claim 9, in which, in a UMTS type system, said radio link reconfiguration command message corresponds to a “radio link reconfiguration request” message.

14. Method according to claim 1, in which said initial transmission power is used by said first network element for a radio admission control algorithm.

15. Method according to claim 1, in which said initial transmission power is used by said first network element for a power control algorithm.

16. Network element, including means for implementing a method according to claim 1.

17. Base station controller (RNC₁), including means (1) for transmitting to a base station (node B) at least one information element indicating the initial transmission power for transmission to a mobile terminal (UE), in the case of radio link reconfiguration between said base station and said mobile terminal, which can produce a change in the transmission power for this radio link.

18. Base station controller (RNC₂), including means (4) for transmitting to a base station controller (RNC₃) at least one information element indicating the initial transmission power for transmission to a mobile terminal (UE), in the case of radio link reconfiguration between a base station and said mobile terminal, which can produce a change in the transmission power for this radio link.

19. Base station controller (RNC₃), including means (5) for receiving from a base station controller (RNC₂) at least one information element indicating the initial transmission power for transmission to a mobile terminal, in the case of radio link reconfiguration between a base station and said mobile terminal, which can produce a change in the transmission power for this radio link, and for retransmitting said information element to said base station.

20. Base station (node B) including means (2, 6) for receiving from a base station controller (RNC₁, RNC₃) at least one information element indicating the initial transmission power for transmission to a mobile terminal (UE), in the case of radio link reconfiguration between said base station and said mobile terminal, which can produce a change in the transmission power for this radio link.

21. Base station according to claim 20, including means (3, 7) for using said information element for a radio admission control algorithm.

22. Base station according to claim 20, including means (3, 7) for using said information element for a power control algorithm.

23. Mobile radiocommunication system, including means for implementing a method according to claim 1.
